(19) United States
(12) Patent Application Publication
(10) Pub. No.: US 2011/0279226 A1
(43) Pub. Date: Nov. 17, 2011

(54) CHARGING SYSTEM AND CHARGING METHOD THEREOF

(75) Inventors: CHIH-HUNG CHEN, Hsinchu City (TW); YEN-LING TING, Taichung City (TW)

(73) Assignee: TOPCO SCIENTIFIC CO.,LTD., Taipei City (TW)

(21) Appl. No.: 12/854,305

(22) Filed: Aug. 11, 2010

(30) Foreign Application Priority Data
May 14, 2010 (TW) 099115602

(51) Int. Cl. G05B 19/00

(52) U.S. Cl. 340/5.8

(57) ABSTRACT

A charging system and the charging method are provided. The charging system comprises a charging unit and a rechargeable unit. The rechargeable unit includes a first wireless communication apparatus and a first wireless charging module. The charging unit includes a second wireless communication apparatus, a second wireless charging module and a processing module. The charging method comprises the steps of: transmitting an authentication code and a charging signal to the second wireless communication apparatus by the first wireless communication apparatus; verifying the authentication code by the processing module after receiving the authentication code and the charging signal from the second wireless communication apparatus; charging the first wireless charging module via wireless charging by the second wireless charging module controlled by the processing module when the authentication code is verified.

### BACKGROUND OF THE INVENTION

1. Field of the Invention

The present invention relates to a charging system and its charging method, and more particularly to a charging system and the charging method suitable for wirelessly charging a power vehicle.

2. Description of the Related Art

Nowadays, the market share of power vehicles is quite low, and the major problem is that batteries for power storage provide limited sustainability. Comparing to the refueling frequencies of automobiles as one to two times per month, the power vehicle has to be charged every time before driving it. Also, the power charging usually takes several hours, which makes the use of power vehicle impracticable. In addition, the current power charging mode is usually connected to private power sources, rather than commercialized power-charging locations. In another word, the lack of power-charging locations, inconvenience of charging, and the non-commercialized charging mode are the major barriers preventing the development of the power vehicles.

### SUMMARY OF THE INVENTION

In view of the shortcomings of the prior art, the inventor of the present invention based on years of experience in the related industry to conduct extensive researches and experiments, and finally developed a charging system and a charging method thereof to overcome the defect that is unable to rapidly and conveniently charge a power vehicle real-time to cause insufficient cruise distance of the power vehicle.

To achieve the foregoing objective, the charging system of the present invention comprises a rechargeable unit and a charging unit. The rechargeable unit comprises a first wireless communication apparatus and a first wireless charging module. The charging unit comprises a second wireless communication apparatus, a second wireless charging module and a processing module. The rechargeable unit is power mobile equipment, and the first wireless communication apparatus of the rechargeable unit sends an authentication code and a charging signal through wireless transmission. The first wireless charging module is charged through wireless charging. The charging unit is a fixed type charging appliance. The second wireless communication apparatus of the charging unit receives the authentication code and the charging signal through wireless transmission. The second wireless charging module charges the first wireless charging module through wireless charging. The processing module receives the authentication code and the charging signal from the second wireless communication apparatus and verifies the authentication code. After the authentication code is verified, the processing module controls the second wireless charging module to wirelessly charge the first wireless charging module based upon the charging signal.

The first wireless charging module further comprises a fast rechargeable battery. The second wireless charging module charges the fast rechargeable battery through wireless charging.

The second wireless charging module charges the fast rechargeable battery through electromagnetic induction, magnetic resonance, microwave propagation or combination thereof.

The fast rechargeable battery comprises at least one super-capacitor and at least one storage battery. The at least one super-capacitor is an ultra-capacitor, a gold capacitor, a farad capacitor or an electrical double-layer capacitor. The at least one storage battery is a lead-acid storage battery, a lithium battery, a lithium ion battery, a fuel cell or an air battery.

The first wireless communication apparatus and the second wireless communication apparatus are a radio frequency identification system (RFID), an infrared communication system, a wireless fidelity system (Wi-Fi), a Worldwide Interoperability for Microwave Access System (WiMAX), a High-Speed Data Packet Access System (HSDPA), a Bluetooth communication system, a Wireless Access in the Vehicular Environment Apparatus (WAVE), a Dedicated Short Range Communication Apparatus (DSRC) or a Near Field Communication Apparatus (NFC).

The power mobile equipment is an electric vehicle, an electric bus, an electric bicycle, an electric boat, a mobile multimedia entertainment device or a mobile phone. The authentication code is taken as identification for the power mobile equipment.

To achieve the foregoing objective, a charging method of the present invention is provided, which is suitable for a charging system. The charging system comprises a rechargeable unit and a charging unit. The rechargeable unit is power mobile equipment and comprises a first wireless communication apparatus and a first wireless charging module. The charging unit is a fixed type charging appliance and comprises a second wireless communication apparatus, a second wireless charging module and a processing module. The charging method comprises following steps of firstly sending an authentication code and a charging signal to the second wireless communication apparatus via wireless transmission by the first wireless communication apparatus; receiving the authentication code and the charging signal from the second wireless communication apparatus and verifying the authentication code by the processing module; and charging the first wireless charging module via wireless charging by the second wireless charging module controlled by the processing module based upon the charging signal after verifying the authentication code.

The first wireless charging module further comprises a fast rechargeable battery. The second wireless charging module charges the fast rechargeable battery through wireless charging.

The second wireless charging module charges the fast rechargeable battery through electromagnetic induction, magnetic resonance, microwave propagation or combination thereof.

The fast rechargeable battery comprises at least one super-capacitor and at least one storage battery. The at least one super-capacitor is an ultra-capacitor, a gold capacitor, a farad capacitor or an electrical double-layer capacitor. The at least one storage battery is a lead-acid storage battery, a lithium battery, a lithium ion battery, a fuel cell or an air battery.

The first wireless communication apparatus and the second wireless communication apparatus are a radio frequency identification system (RFID), an infrared communication system, a wireless fidelity system (Wi-Fi), a Worldwide Interoperability for Microwave Access System (WiMAX), a High-Speed Data Packet Access System (HSDPA), a Bluetooth communication system, a Wireless Access in the Vehicular Environment Apparatus (WAVE), a Dedicated Short Range Communication Apparatus (DSRC) or a Near Field Communication Apparatus (NFC).

The power mobile equipment is an electric vehicle, an electric bus, an electric bicycle, an electric boat, a mobile multimedia entertainment device or a mobile phone. The authentication code is taken as identification for the power mobile equipment.

The charging system and the charging method of the present invention have one or more advantages as the following:
(1). The charging system and the charging method can rapidly charge the power of the rechargeable battery through wireless charging so as to enhance the convenience of supplementary power for the electric vehicle.
(2). The charging system and the charging method can rapidly charge the battery through the arrangement and charge through wireless charging. The problems of inconveniently charging at improper locations and long charging time can be solved.
(3). The charging system and the charging method are performed by adopting wireless charging. There is no need to install power lines and connectors so as to avoid inconsistent specifications at plugs provided by different companies.
(4). The charging unit of the charging system can be disposed underground. Thus, the charging unit can be directly disposed to a parking lot or a gas station to increase the charging convenience.
(5). The charging system and the charging method do not need to be operated by personals while in the charging mode. The personnel costs can be greatly reduced.

### BRIEF DESCRIPTION OF THE DRAWINGS

FIG. 1 is a block diagram of a charging system according to a present invention;

FIG. 2 is a schematic diagram of a charging system according to an embodiment of the present invention; and

FIG. 3 is a flow chart of a charging method according to the present invention.

### DETAILED DESCRIPTION OF THE PREFERRED EMBODIMENTS

The foregoing and other technical characteristics of the present invention will become apparent with the detailed description of the preferred embodiments and the illustration of the related drawings.

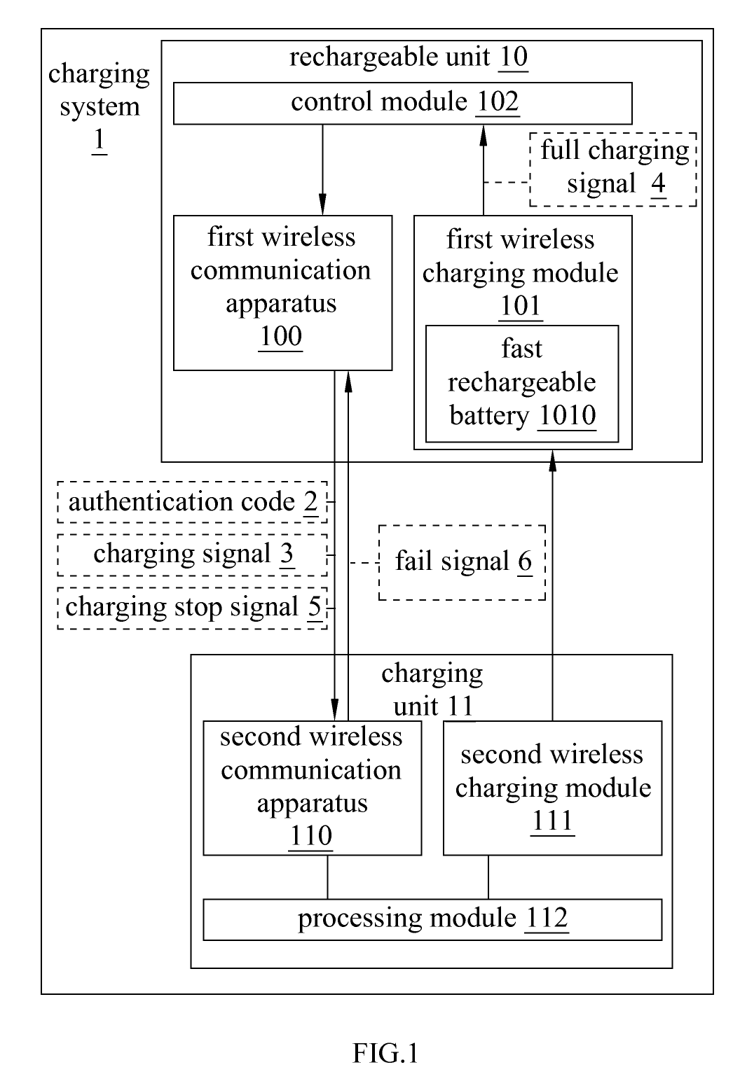

With reference to FIG. 1 for a block diagram of a charging system in accordance with the present invention is depicted. As shown in the figure, the charging system 1 of the present invention comprises a rechargeable unit 10 and a charging unit 11. The rechargeable unit 10 comprises a first wireless communication apparatus 100 and a first wireless charging module 101. The charging unit 11 comprises a second wireless communication apparatus 110, a second wireless charging module 111 and a processing module 112. The rechargeable unit 10 is power mobile equipment. The power mobile equipment can be an electric vehicle, an electric bus, an electric bicycle, an electric boat, a mobile multimedia entertainment device or a mobile phone. The first wireless communication apparatus 100 of the rechargeable unit sends an authentication code 2 and a charging signal 3 through wireless transmission. The first wireless charging module 101 is charged by wireless charging. The charging unit 11 can be a fixed type charging appliance. The second wireless communication apparatus 110 of the charging unit receives the authentication code 2 and the charging signal 3 through wireless transmission. The second wireless charging module 111 charges the first wireless charging module 101 through wireless charging. After receiving the authentication code 2 and the charging signal 3 from the second wireless communication apparatus 110, the processing module 112 verifies the authentication code 2. The authentication code 2 can be taken as identification for the power mobile equipment. After verifying the authentication code 2, the processing module 112 controls the second wireless charging module 111 to charge the first wireless charging module 101 through wireless charging.

The first wireless charging module 101 further comprises a fast rechargeable battery 1010. The second wireless charging module 111 charges the fast rechargeable battery 1010 through wireless charging. In some preferred embodiments, the second wireless charging module 111 charges the fast rechargeable battery 1010 through electromagnetic induction, magnetic resonance, microwave propagation or combination thereof. Since the charging system 1 adopts wireless charging to charge the battery, there is no need to dispose power lines and connectors so as to avoid inconsistent specifications at plugs provided by different companies.

In addition, the fast rechargeable battery 1010 can be at least one super-capacitor and at least one storage battery. The at least one super-capacitor is an ultra-capacitor, a gold capacitor, a farad capacitor or an electrical double-layer capacitor. The at least one storage battery is a lead-acid storage battery, a lithium battery, a lithium ion battery, a fuel cell or an air battery. Compared with the conventional storage battery, the super-capacitor has the advantage of fast charging speed and can quickly charge at few seconds to few minutes. The conventional storage battery may need few hours. The super-capacitor prolongs the charging/discharging service life to achieve above 500000 times or above 90000 hours and is better than the charging/discharging service life (smaller than 1000 times) of the storage battery. Moreover, the first wireless communication apparatus 100 and the second wireless communication apparatus 110 can be a radio frequency identification system (RFID), an infrared communication system, a wireless fidelity system (Wi-Fi), a Worldwide Interoperability for Microwave Access System (WiMAX), a High-Speed Data Packet Access System (HSDPA), a Bluetooth communication system, a Wireless Access in the Vehicular Environment Apparatus (WAVE), a Dedicated Short Range Communication Apparatus (DSRC) or a Near Field Communication Apparatus (NFC).

Furthermore, the rechargeable unit 10 can comprise a control module 102. The first wireless charging module 101 sends a full charging signal 4 to the control module 102 after fully charging power. The control module 102 then controls the first wireless communication apparatus 100 to send a charging stop signal 5 to the second wireless communication apparatus 110. After the processing module 112 receives the charging stop signal 5 from the second wireless communication apparatus 110, the second wireless charging module 111 is controlled to stop wireless-charging the first wireless charging module 101. The deduction action will be performed upon the authentication code 2. In the embodiment, the processing module 112 of the rechargeable unit 10 can be linked to related financial institutions or prepaid card companies. While verifying the authentication code 2, these financial institutions or prepaid card companies can be linked to verify whether or not account numbers represented by the authentication code 2 has an authority to perform the charging. When the charging is completed, the processing module 112 is linked to these financial institutions or prepaid card companies to correspondingly deduct the account represented by the authentication code 2.

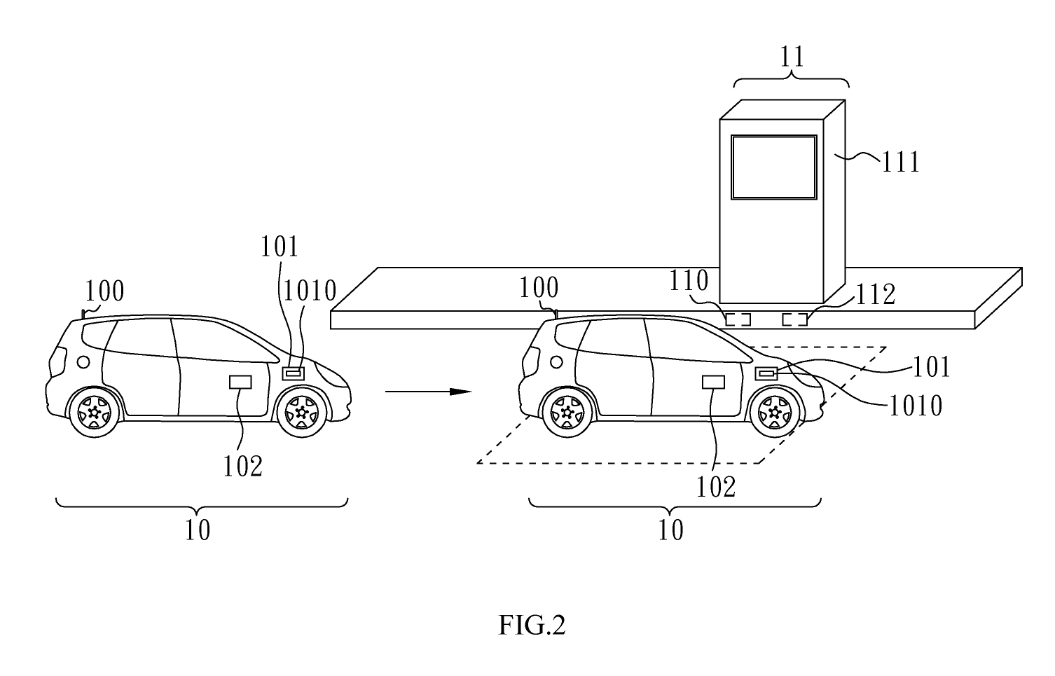

With reference to FIG. 2 for a schematic diagram of a charging system in accordance with an embodiment of the present invention is depicted. As shown in the figure, the charging system 1 comprises a rechargeable unit 10 and a charging unit 11. In the embodiment, the rechargeable unit 10 is a power vehicle. The charging unit 11 is a charging station. When the rechargeable unit 10 enters a scope (a dotted line in the figure) capable of allowing the second wireless communication apparatus 110 of the charging unit 11 to receive a charging signal (authentication code request) sent from the first wireless communication apparatus 100, the processing module 112 starts to link the related financial institutions or prepaid card companies to verify the identification and to check available money. When the power vehicle represented by the authentication is verified to have a charging authority, the processing module 112 controls the second wireless charging module 111 to charge the fast rechargeable battery 1010 of the first wireless charging module 101 based upon the charging signal. However, when the authentication code fails the verification, the charging unit 11 then sends a fail signal 6 (as shown in FIG. 1) to the rechargeable unit 10. The charging unit 11 of the charging system 1 of the present invention can be disposed underground. In other words, the charging unit can be directly disposed to parking lots or gas stations to further increase the charging convenience. The charging system 1 of the present invention does not to be operated by personals to greatly save the personnel costs while charging the power.

If the power vehicle leaves the communication scope of the second wireless communication apparatus 110 and the first wireless communication apparatus 100 and the fast rechargeable battery 1010 is not fully charged yet, the processing module 112 is linked to these financial institutions or prepaid card companies to correspondingly deduct the account represented by the authentication code. While the fast rechargeable battery 1010 is fully charged, the first wireless charging module 101 then sends a full charging signal to the control module 102. The control module 102 then controls the first wireless communication apparatus 100 to send a charging stop signal 5 to the second wireless communication apparatus 110. The processing module 112 controls the second wireless charging module 111 to stop wireless-charging the first wireless charging module 101, thereby performing the deduction based upon the authentication code 2.

To clearly depict the invention, a flow chart is provided to further explain the present invention although the foregoing depictions completely show the concept and embodiments.

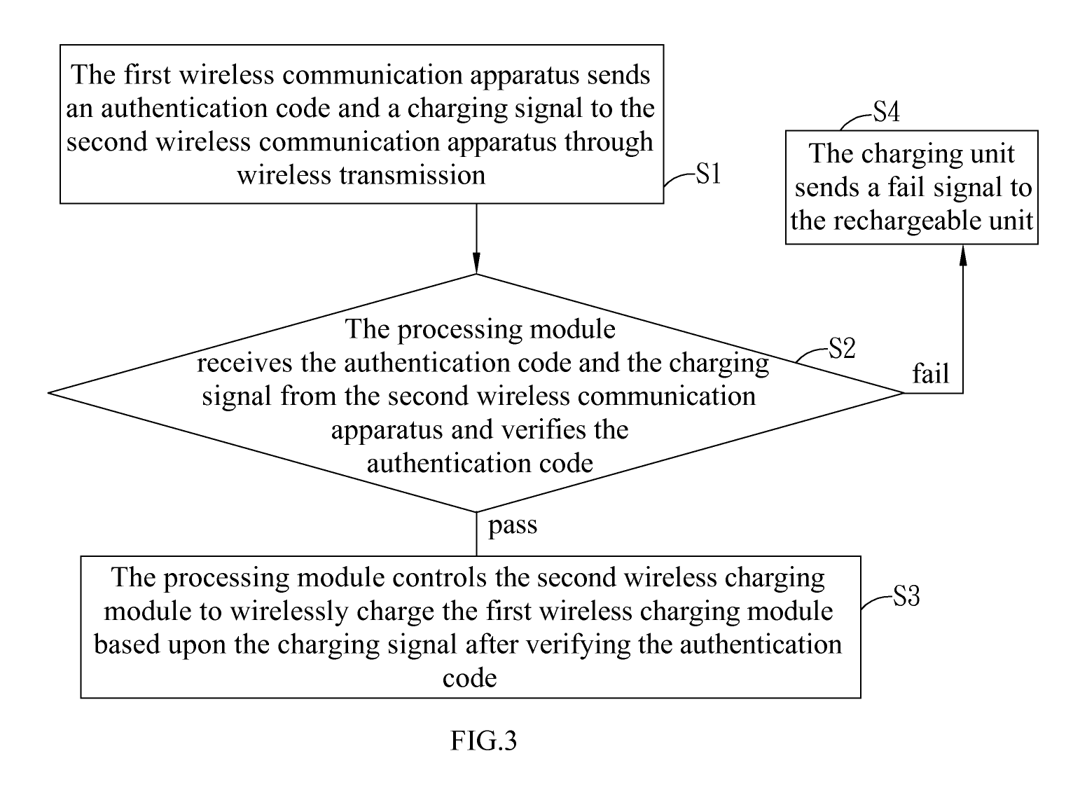

With reference to FIG. 3 for a flow chart of a charging method in accordance with a present invention is depicted. As shown in the figure, the charging method of the present invention is suitable for a charging system. The charging system comprises a rechargeable unit and a charging unit. The rechargeable unit is power mobile equipment and comprises a first wireless communication apparatus and a first wireless charging module. The charging unit is a fixed type charging appliance and comprises a second wireless communication apparatus, a second wireless charging module and a processing module. The charging method of the present invention comprises following steps: (S1) The first wireless communication apparatus sends an authentication code and a charging signal to the second wireless communication apparatus through wireless transmission. (S2) The processing module receives the authentication code and the charging signal from the second wireless communication apparatus and verifies the authentication code. (S3) The processing module controls the second wireless charging module to wirelessly charge the first wireless charging module based upon the charging signal after verifying the authentication code.

In step (S2), when the authentication code fails to pass the verification, a step (S4) of sending a fail signal to the rechargeable unit from the charging unit.

The detail depiction of the foregoing flow chart is similar to the demonstration of the foregoing charging system, and there is no need to describe in detail.

The charging system and the charging method of the present invention provide a charging predetermined position capable of being charged and incorporate the rechargeable battery capable of being rapidly charged. For users, the charging time and cruise distance of an electric automobile are no longer influences. In addition, the electric automobile does not need to install several rechargeable batteries any more or expensive high energy density battery. It does not only reduce the weight of the electric automobile to further enhance the cruising range, but also decreases the cost of the electric automobile greatly.

The present invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A charging system comprising:
a rechargeable unit being a power mobile equipment, the rechargeable unit comprising:
a first wireless communication apparatus sending an authentication code and a charging signal through wireless transmission; and
a first wireless charging module charged by wireless charging; and
a charging unit being a fixed type charging appliance, the charging unit comprising:
a second wireless communication apparatus receiving the authentication code and the charging signal through wireless transmission;
a second wireless charging module for charging the first wireless charging module through wireless charging; and
a processing module receiving the authentication code and the charging signal from the second wireless communication apparatus and verifying the authentication code, wherein the processing module controls the second wireless charging module to charge the first wireless charging module through wireless charging after the authentication code is verified.

2. The charging system as recited in claim 1, wherein the first wireless charging module further comprises a fast rechargeable battery, and the second wireless charging module charges the fast rechargeable battery through wireless charging.

3. The charging system as recited in claim 2, wherein the second wireless charging module charges the fast rechargeable battery through electromagnetic induction, magnetic resonance, microwave propagation or combination thereof.

4. The charging system as recited in claim 3, wherein the fast rechargeable battery comprises at least one super-capacitor and at least one storage battery, and the at least one super-capacitor is an ultra-capacitor, a gold capacitor, a farad capacitor or an electrical double-layer capacitor, and the at least one storage battery is a lead-acid storage battery, a lithium battery, a lithium ion battery, a fuel cell or an air battery.

5. The charging system as recited in claim 4, wherein the first wireless communication apparatus and the second wireless communication apparatus are a radio frequency identification system (RFID), an infrared communication system, a wireless fidelity system (Wi-Fi), a Worldwide Interoperability for Microwave Access System (WiMAX), a High-Speed Data Packet Access System (HSDPA), a Bluetooth communication system, a Wireless Access in the Vehicular Environment Apparatus (WAVE), a Dedicated Short Range Communication Apparatus (DSRC) or a Near Field Communication Apparatus (NFC).

6. The charging system as recited in claim 5, wherein the power mobile equipment is an electric vehicle, an electric bus, an electric bicycle, an electric boat, a mobile multimedia entertainment device or a mobile phone, and the authentication code is taken as an identification for the power mobile equipment.

7. A charging method applied to a charging system, the charging system comprising a rechargeable unit and a charging unit, the rechargeable unit being a power mobile equipment and comprising a first wireless communication apparatus and a first wireless charging module, the charging unit being a fixed type charging appliance and comprising a second wireless communication apparatus, a second wireless charging module and a processing module, the charging method comprising the following steps:
sending an authentication code and a charging signal to the second wireless communication apparatus via wireless transmission by the first wireless communication apparatus;
receiving the authentication code and the charging signal from the second wireless communication apparatus and verifying the authentication code by the processing module; and
charging the first wireless charging module via wireless charging by the second wireless charging module controlled by the processing module based upon the charging signal after verifying the authentication code.

8. The charging method as recited in claim 7, wherein the first wireless charging module further comprises a fast rechargeable battery, and the second wireless charging module charges the fast rechargeable battery through wireless charging.

9. The charging method as recited in claim 8, wherein the second wireless charging module charges the fast rechargeable battery through electromagnetic induction, magnetic resonance, microwave propagation or combination thereof.

10. The charging method as recited in claim 9, wherein the fast rechargeable battery comprises at least one super-capacitor and at least one storage battery, and the at least one super-capacitor is an ultra-capacitor, a gold capacitor, a farad capacitor or an electrical double-layer capacitor, and the at least one storage battery is a lead-acid storage battery, a lithium battery, a lithium ion battery, a fuel cell or an air battery.

11. The charging method as recited in claim 10, wherein the first wireless communication apparatus and the second wireless communication apparatus are a radio frequency identification system (RFID), an infrared communication system, a wireless fidelity system (Wi-Fi), a Worldwide Interoperability for Microwave Access System (WiMAX), a High-Speed Data Packet Access System (HSDPA), a Bluetooth communication system, a Wireless Access in the Vehicular Environment Apparatus (WAVE), a Dedicated Short Range Communication Apparatus (DSRC) or a Near Field Communication Apparatus (NFC).

12. The charging method as recited in claim 11, wherein the authentication code is taken as an identification for the power mobile equipment.

13. The charging method as recited in claim 12, wherein the power mobile equipment is an electric vehicle, an electric bus, an electric bicycle, an electric boat, a mobile multimedia entertainment device or a mobile phone.
